(19) United States
(12) Patent Application Publication
(10) Pub. No.: US 2008/0124566 A1
(43) Pub. Date: May 29, 2008

(54) Composite Material Comprising Ultra-Hard Particles Embedded in a Metal or Metal Alloy Matrix and Diaphragm Made Thereof

(76) Inventors: Clint Guy Smallman, Egham (GB); Geoffrey Alan Scarsbrook, Berkshire (GB); Geoffrey John Davies, Randburg (ZA); John Robert Brandon, Hampshire (GB)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/720,360

(22) PCT Filed: Nov. 25, 2005
(86) PCT No.: PCT/IB05/03546

§ 371 Date: Nov. 15, 2007

Related U.S. Application Data
(60) Provisional application No. 60/636,110, filed on Dec. 16, 2004.

(30) Foreign Application Priority Data
Nov. 26, 2004 (GB) 0426143.4

(51) Int. Cl. H04R 7/02; C22C 26/00

(52) U.S. Cl. 428/606; 156/233; 428/544

(57) ABSTRACT

A component that is rigid and three-dimensional and has a relatively low mass. The component has a foil body formed of a metal or metal alloy matrix that is embedded with ultra-hard particles or grit, such as diamond and/or cBN. It can be used in applications where a combination of high rigidity and low mass is required, such as in audio applications, for example.

### BACKGROUND OF THE INVENTION

THIS invention relates to components, in particular audio components, which have high rigidity and low mass, and to composite materials used in their manufacture, and methods of manufacturing such composite materials and components.

There are many applications requiring structures of high rigidity and low mass. Typical applications are in the aerospace industry where virtually all mechanical components must have a high rigidity to mass ratio.

However, there is a range of other applications for light but rigid bodies. A particular application is the production of drive units for acoustic loudspeakers, and in particular high frequency tweeters for the accurate reproduction of high frequency sounds.

Human hearing is commonly accepted to cover the range 20 Hz-20 kHz. Therefore a high quality loudspeaker system needs to accurately reproduce frequencies at least over this frequency range. Typical high performance loudspeakers employ two or more drive units that are effectively mechanical transducers converting an electrical signal into a sound (compression) wave. Each drive unit will cover a specific part of the audible range. The drive unit can be approximated to a piston moving backwards and forwards to create compression and rarefaction of air.

It is well known that small pistons can efficiently generate high sound pressure levels at high frequencies while larger diameter pistons are required to produce comparable sound pressure levels at lower frequencies with comparable efficiency. Typically a 25 mm diameter drive unit can operate in the frequency range 2-20 kHz while a larger drive unit of, say, 100-250 mm diameter can produce frequencies in the range down to 100 Hz and below. However, larger drive units cannot easily be used to produce high frequency sounds due to the problems of unwanted oscillations or break-up that can occur. Human ears are very sensitive to the ‘colouration’ of the sound by these break-up modes. For this reason high frequency drive units have a small diameter. Recently it has been demonstrated that the presence of break-up modes at frequencies that lie outside the accepted range of human hearing can cause audible degradation of the source. For this reason several attempts have been made to produce drive units that can operate at frequencies higher than 20 kHz without distortion.

The ideal loudspeaker would have very low mass, to enhance its sensitivity, and very high rigidity with no resonances within or close to the frequency spectrum of operation which could affect the audible output. All practical tweeter devices naturally have mass, and also resonances. Developments in audio media and amplification systems, such as the so called Super Audio formats (SACD and DVDA) extend the range of frequencies provided in the drive to modern speakers up to as high as 96 kHz, compared for example with the upper limit of the bandwidth of a standard CD, which is about 22 kHz.

It is well known that lighter and more rigid tweeter structures, fabricated using materials with a higher value of Young's modulus and lower density, show higher frequency resonances. As such, the use of diamond in tweeters is well reported. Prior art records a variety of configurations of speaker dome, fabricated by a range of means, but the performance advantage reported is generally poor and such speaker domes are not in widespread use. There is also substantial prior art in tweeter devices based on other materials such as Al, Be and plastics, and on a range of geometries.

U.S. Pat. No. 5,556,464 discloses the use of diamond domes for speakers, describing in detail the need to terminate the edge of the integral planar flange in a manner designed to control edge cracks developing. DE Patent 10049744 discloses the use of a diamond dome mounted concave onto a voice coil former, such that the edges of the dome are unsupported. This type of geometry provides for a range of unwanted resonances in the dome structure that may colour the output sound. More recently, Bowers and Wilkins (B&W Loudspeakers Ltd, Dale Road, Worthing, West Sussex, England) have launched a range of speakers using diamond domes, the design of which is described in co-pending GB patent application 0408458.8 and in a technical note “Development of the B&W 800D” published by B&W on 17 Nov. 2004.

### SUMMARY OF THE INVENTION

According to the present invention a component, in particular an audio component, comprises a foil body formed of particles or grit of ultra-hard material embedded in a metal or metal alloy matrix.

The ultra-hard particles or grit are preferably diamond or cBN (cubic boron nitride) particles or grit.

By embedding diamond or cBN particles or grit in a metal or metal alloy matrix, which is then fabricated into a thin foil body, typically into a three dimensional structure, the component has a higher specific Young's modulus and/or lower density than would be achieved by the use of metal or metal alloy alone.

The metal or metal alloy matrix preferably comprises a metal (pure or alloyed) having a high specific stiffness. Such metal may include, for example, aluminium, magnesium, beryllium, titanium or the like.

In a preferred embodiment of the invention, the audio component comprises a dome segment.

The shape of the component is preferably a segment of a sphere. Other preferred shapes for the audio component are segments of ellipsoids, paraboloids and hyperboloids with a rotational symmetry axis and no abrupt change in radius of curvature, defined by rotating a segment of an ellipse or other conic section about a symmetry axis.

Preferably, the component has an integral coil mounting flange or tube, such that it is suitable for use as a speaker dome.

In a particularly preferred embodiment of the invention, the component is suitable for use as a high performance tweeter.

The invention extends to a composite material comprising diamond particles or grit embedded in a metal or metal alloy matrix comprising a metal selected from aluminium, magnesium, beryllium and titanium, and combinations thereof.

The invention also extends to a composite material comprising a foil body formed of diamond particles or grit embedded in a metal or metal alloy matrix, the diamond particles or grit being formed by chemical vapour deposition.

The invention extends further to a method of manufacturing a three-dimensional structure having relatively high rigidity and low mass comprising providing a source of ultra-hard abrasive particles or grit and a metal matrix material, compacting the ultra-hard abrasive particles or grit and the metal matrix material together to form a composite strip or foil, and shaping the composite strip or foil into the three-dimensional structure.

### BRIEF DESCRIPTION OF THE DRAWINGS

The invention will now be described in more detail, by way of example only, with reference to the accompanying figures, in which:

FIG. 1 is a graph showing the upper and lower bounds in the variation in Young's modulus or stiffness of a composite material, here exemplified by diamond filler in an aluminium matrix, as a function of the volume fraction of the filler material;

FIG. 2 is a perspective view of a preferred embodiment of the component of the invention; and

FIG. 3 is a cross-section side view of the component of FIG. 2 on the line 3-3.

### DETAILED DESCRIPTION OF PREFERRED EMBODIMENTS

The invention is directed at the formation of a component that is rigid and three-dimensional, and has a relatively low mass. The component comprises a foil body formed of a metal or metal alloy matrix composite embedded with ultra-hard particles or grit, preferably diamond and/or cBN particles or grit. The component can be used in applications where a combination of high rigidity and low mass is required, such as in audio applications, for example.

For clarity, certain of the terminology is defined below.

Stiffness is a specific technical term relating to the Elastic Modulus (Young's Modulus) of a material:
Stiffness=Young's Modulus=E.

Often a second key parameter is the density of a material, and so a further term is defined as:
Specific Stiffness=E/ρ, where ρ=density.

However, using material with the same stiffness it is possible to construct structures which are much less compliant than others, for example comparing I beams over flat plates. Thus:
Rigidity=a structure's resistance to deformation by bending.

In the specific instance of a structural foam, the rigidity of the foam varies in proportion to its density and with the cube of its thickness. Note that the rigidity is with respect to bending. With respect to compression, the deformation varies approximately in inverse proportion to the density and in inverse proportion to the thickness.

In a structural foam or partially densified material, a further key parameter is the sheet density or density per unit area of the sheet:
Sheet density=ρ/A, where A=area in the plane of the sheet.

In a spherical dome or similar three-dimensional structure, which is preferably defined by the rotation of an ellipse or other conic section, the rigidity is a function of the wall or shell thickness of the structure, and also of parameters such as the radius of curvature of the sphere (or other structure) of which the dome (or similar three-dimensional structure) forms a part, and the proportion of the sphere (or other structure) which forms the dome (or similar three-dimensional structure).

These definitions of stiffness, specific stiffness, rigidity and sheet density are assumed throughout this specification.

A three-dimensional component or body formed from a diamond or cBN loaded metal or metal alloy matrix composite will preferably fulfill one or more of the following criteria:
a) the foil body will be formed from a thin layer, and in particular the thickness of the layer forming the foil body will preferably not exceed 500 μm, more preferably not exceed 200 μm, even more preferably not exceed 100 μm, even more preferably not exceed 70 μm, and most preferably not exceed 50 μm;
b) the thickness of the layer forming the foil body will preferably exceed 5 μm, more preferably exceed 10 μm, even more preferably exceed 20 μm, even more preferably exceed 30 μm, and most preferably exceed 40 μm;
c) the foil body will preferably contain diamond or cBN or a mixture of the two, preferably in a total concentration by volume exceeding 2%, more preferably exceeding 5%, more preferably exceeding 10%, more preferably exceeding 20%, more preferably exceeding 30%, even more preferably exceeding 40%, and most preferably exceeding 50%;
d) the grit size as characterised by the mean diameter prior to compaction is preferably less than 60 μm, more preferably less than 30 μm, even more preferably less than 20 μm, even more preferably less than 15 μm, and most preferably less than 10 μm in size (in a multi-modal grit distribution, this limit relates to the largest grit size used);
e) the grit size as characterised by the mean diameter is preferably greater than 0.2 μm, more preferably greater than 0.5 μm, even more preferably greater than 1 μm, and most preferably greater than 4 μm in size (in a multi-modal grit distribution, this limit relates to the largest grit size used);
f) the ratio of the grit size as characterised by the mean diameter prior to compaction to the final thickness of the metal matrix strip is preferably less than 0.5, more preferably less than 0.4, even more preferably less than 0.3, even more preferably less than 0.25, most preferably less than 0.22 (in a multi-modal grit distribution, this limit relates to the largest grit size used);
g) the ratio of the grit size as characterised by the mean diameter prior to compaction to the final thickness of the metal matrix strip is preferably greater than 0.05, more preferably greater than 0.1, even more preferably greater than 0.15, even more preferably greater than 0.18, and most preferably greater than 0.2 (in a multi-modal grit distribution, this limit relates to the largest grit size used);
h) the ratio of the grit size as characterised by the mean diameter after compaction to the final thickness of the metal matrix strip is preferably less than 0.3, more preferably less than 0.25, most preferably less than 0.22 (in a multi-modal grit distribution, this limit relates to the largest grit size used);
i) the ratio of the grit size as characterised by the mean diameter after compaction to the final thickness of the metal matrix strip is preferably greater than 0.05, more preferably greater than 0.1, even more preferably greater than 0.15, even more preferably greater than 0.18, and most preferably greater than 0.2 (in a multi-modal grit distribution, this limit relates to the largest grit size used);
j) the layer forming the foil body may be densified, preferably fully densified, or it may be only partially densified or porous.

In particular the invention relates to the use of such components in the application of loudspeaker drive units.

The component fabricated according to any of the above criteria may be a dome segment, which may have an integral coil mounting flange or tube so that it is suitable for use as a speaker dome. In particular, the component is a high performance tweeter component. Preferably, the tweeter component demonstrates one or more of the following properties, when tested in an ideal mount essentially free of effects from the surround:
a) a break-up frequency that is greater than 31 kHz, preferably greater than 45 kHz, more preferably greater than 55 kHz, even more preferably greater than 65 kHz, and most preferably greater than 75 kHz;
b) a deviation in the on axis response curve from the modeled ideal on axis response curve, allowing for phase roll-off, measured at 20 kHz, preferably at 30 kHz, more preferably at 40 kHz, and even more preferably at 50 kHz, which is less than 5 dB, preferably less than 3 dB, more preferably less than 2 dB, even more preferably less than 1, and most preferably less than 0.5 dB; and
c) a deviation in the on axis response curve from a flat response measured at 20 kHz, preferably at 30 kHz, more preferably at 40 kHz, and even more preferably at 50 kHz, which is less than 5 dB, preferably less than 3 dB, more preferably less than 2 dB, even more preferably less than 1, and most preferably less than 0.5 dB.

A tweeter component which exhibits one or more of the above characteristics a) to c) would generally be described by a person skilled in the art as being ‘a high performance tweeter component’.

A tweeter to the above specification can be used to provide output for modern audio sources at a lower cost than solid diamond tweeters and of a higher audio quality than other alternatives to the solid diamond tweeter.

In a preferred version of this embodiment of the invention, the high performance tweeter dome is fabricated to one or more of the following criteria:
a) the shape of the tweeter component is convex when viewed from the side of the listener;
b) the shape of the tweeter component is based on a spherical dome;
c) the shape of the tweeter component is axially symmetric and based on an ellipse in which the two axes a, b (where a>=b) are such that a/b is less than 1.5, preferably less than 1.2, more preferably less than 1.1, even more preferably less than 1.05, and most preferably less than 1.01;
d) the shape of the tweeter component is axially symmetric, the curved part being formed by taking a conic section and rotating it about its symmetry axis, the conic section being defined by a plane parallel to the rotational symmetry axis of a circular cone of appropriate geometry;
e) the tweeter component is fabricated with an integral axial tube component that either directly provides the former for the voice coils or alternatively provides the means of mechanical attachment for a separate voice coil former, made for example from Al or Kapton;
f) the tweeter component is fabricated to a specific profile of sheet density and local rigidity, by such means as locally varying the layer or sheet thickness, the degree of densification, or the distribution of densification through the thickness, or the distribution of grit particles where present, both in the plane of the layer and through its thickness—preferably the profile of these parameters is selected to particularly enhance the rigidity in the region of the edge of the component and the skirt or voice coil mount, and to particularly reduce the mass in the region of the centre of the component;
g) the diameter of the three dimensionally curved portion of the tweeter component when viewed down its axis of rotational symmetry exceeds 20 mm, preferably exceeds 24 mm, more preferably exceeds 26 mm, even more preferably exceeds 28 mm, and most preferably exceeds 30 mm;
h) the radius of curvature of the tweeter component is constant and exceeds 15 mm, preferably exceeds 18 mm, more preferably exceeds 20 mm, even more preferably exceeds 22 mm, and most preferably exceeds 24 mm;
i) the radius of curvature of the tweeter component is not constant and exceeds 15 mm, preferably exceeds 18 mm, more preferably exceeds 20 mm, even more preferably exceeds 22 mm, and most preferably exceeds 24 mm at all points.

In the case of a fully densified body formed of a composite material consisting of grit embedded in a metal or metal alloy, the increase in the stiffness of the composite material depends on the Young's modulus of the two materials. In general the stiffness of the filler will be much higher than the matrix material. For example diamond has a Young's modulus of approximately 1,000 GPa while aluminium has a Young's modulus of only 80 GPa. Diamond is therefore over 10 times stiffer than aluminium. The stiffness of a composite material can be estimated to lie between two limits. In the best case it equates to a rule of mixtures while in the worst case the stiffness is calculated using a relationship as follows:

Ec=1/(Vf/Ef)+((1−Vf)/Em),

where:

Ec=the modulus of the composite;

Vf=the volume fraction of the filler;

Ef=the Young's modulus of the filler; and

Em=the Young's Modulus of the matrix.

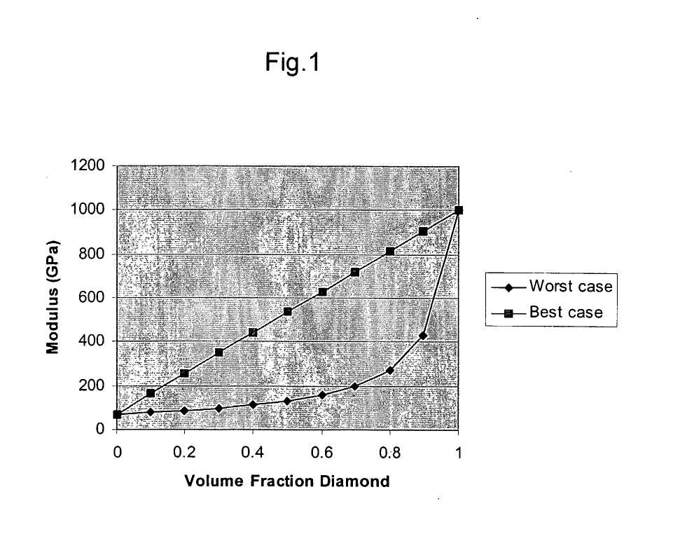

Data is plotted in the accompanying FIG. 1 for a composite consisting of aluminium and diamond. From this data it can be seen that a large fraction of high modulus filler is required to ensure that the modulus of the composite is as high as possible. The largest increases in performance are achieved by increasing the fraction to above 80%. This fraction substantially exceeds that which can theoretically be obtained by close packing mono-modal spherical powders, and demonstrates the benefit of using multi-modal grit distributions, such as those described later.

An alternative method of producing a high specific stiffness structure is to leave much of the interstitial volume unoccupied i.e. a partially densified or porous structure. This method has several advantages. Firstly, where filler is used, the high modulus filler particles are in touch with one another and give a good stiffness. Secondly, the density of the structure is reduced and therefore so is the mass for a given thickness. The reduced effective density can also be used to advantage by thickening the structure. Creating such partially densified or porous structures can limit the means by which the material is fabricated and formed into shape. In one method, a high modulus filler is coated with a suitable metal layer of prescribed thickness. The coated powder is then pressed into a compact of near net shape using organic binders (e.g. polyethylene glycol, PEG) and finally sintered to produce a partially densified yet integral structure.

In partially densified metal material, containing ultra-hard grit or otherwise, the density of the final form may be selectively varied, either through thickness or across the major dimensions of the component. Thus the layer forming the component may be fabricated to a specific profile of sheet density and local rigidity, by such means as locally varying the layer or sheet thickness, the degree of densification, or the distribution of densification through the thickness, or the distribution of grit particles where present, both in the plane of the layer and through its thickness. For example, by increasing the density of the material at the surfaces of the layer compared to the interior, this increases the rigidity for a given thickness and mass. Alternatively, where grit is present, by increasing the grit particle density at the surfaces of the layer compared to the interior, this also increases the rigidity for a given thickness and mass. These two effects can be combined with one another, or with variations in the thickness of the layer. The optimum choice for the many different possibilities depends on the precise geometry of the component and the details of the manufacturing method used.

Typical metal matrix composites use a filler phase of high stiffness which has a large aspect ratio. To first order, the larger the difference in the Young's modulus of the filler compared with the matrix phase, the greater the benefit of a large aspect ratio to the particles forming the filler phase. In the case of sheets formed by compaction, particularly where the filler phase is diamond or cBN, the refinement of particle size/shape which occurs during the repeated compaction and rolling stages limits the advantage of adding in high aspect diamond particles, and thus roughly equiaxed grit particles are generally preferred, particularly where the diamond is high pressure-high temperature (HPHT) synthetic diamond or natural diamond.

The density of Al metal is 2.7 g/cm³. The density of diamond is 3.51 g/cm³, slightly higher, and thus the density of the composite rises slightly with increasing diamond content, but much more slowly than the stiffness. However, in the case of partially dense or porous structures the density may be reduced below the weighted average of the densities of the materials forming the composite, and even below 2.7 g/cm³, whilst the stiffness may still be increased.

The diamond or cBN grit may be prepared by a number of methods known in the art. For example the grit may be prepared by crushing diamond or cBN ultra-hard materials, careful control of which can provide a range of grit morphologies varying in their ‘blockiness’, which is a measure of the aspect ratio or variation between the largest and smallest dimensions of the grit particles. After crushing the grit may undergo further processing, including size grading and chemical rounding or polishing. Diamond and cBN can be obtained in a range of different grit sizes, for example nano diamond is available in sizes typically in the range 5-100 nm, and may be formed by techniques such as explosion synthesis, laser synthesis and others. Larger sizes include the submicron grits in the range 0.1 μm to 1 μm, available for example with a size spread of 50 nm, and micron size grits covering the range 1 μm-20 μm and larger. The larger grit sizes are generally synthesised in a press using high pressure-high temperature techniques, although other appropriate methods may be used.

A further novel method of grit production is by polycrystalline CVD diamond synthesis. Under certain growth conditions it is possible to form columnar grains at high growth rates which are not well inter-grown and can be separated by methods such as chemical etching and crushing. Such diamond grits are unusual in that by careful preparation it is possible to form particles with aspect ratios typically exceeding 1.2 and more typically exceeding 1.5 and even more typically exceeding 2.0 and most typically exceeding 3.0. Grits with much larger aspect ratios are also possible, but these do not generally survive intact during the compaction stage to provide useful benefit in the product. In addition, because of the unique growth direction present in a CVD growth process onto a planar substrate, the internal growth morphology of individual CVD diamond crystallites produced in a polycrystalline diamond layer makes them less susceptible to reduction to equiaxed particle morphologies during the compacting and rolling stages of the present invention than HPHT grits. This enables the formation of metal matrix composites in which the stiffness is enhanced in a specific plane or direction if the long axis of the particles has a preferred orientation distribution, or an overall increase in stiffness if the orientation is random. In some instances, although fracture and size reduction does occur during rolling, the fracture plane preferably contains or lies close to the initial CVD growth direction, retaining or enhancing the higher aspect ratio of the material. The exact orientation distribution of such non-equiaxed particles after compaction and/or rolling depends on the details of the subsequent processing stages. The use of non-equiaxed diamond crystallites or diamond particles is particularly advantageous in porous compacts formed directly to near net shape. Another form of non-equiaxed CVD diamond is polycrystalline whiskers grown for example onto fine filaments, after which the filaments may be chemically removed. These can also be used, although they lack some of the advantages of the non-equiaxed CVD diamond described above.

Grits may be used uncoated or they may be coated. In particular, it is advantageous to bond the matrix material strongly to the diamond or cBN grit particles. This is best achieved with diamond grits by forming a covalent carbide at the surface of the diamond grit. Typically this is produced by coating the particles with a metal such as Ti, Ta, W, Cr, Va, Nb, Zr and forming the associated carbide by reaction with the diamond. A variety of means may be used to coat the grit particles, a key element being to achieve maximum surface coverage using the thinnest layer possible to minimise the effect on the density of the final product. For example, using a Ti coating, the layer thickness is typically in the range 5 nm-80 nm, and more preferably in the range 10 nm-40 nm. A titanium coating on diamond is particularly beneficial when the metal matrix is aluminium or an aluminium alloy, as aluminium carbide is largely ionic rather than covalent. The density of Ti metal is 4.51 g/cm³. Thus it is evident that excess Ti coating above that required to strongly bond the diamond to the Al matrix is undesirable. In this regard, cBN has the advantage of forming a much stronger bond directly with an aluminium matrix, thus the use of coatings in this grit-matrix combination is not generally advantageous.

Methods of applying the metal coating to the grit prior to forming the metal matrix include CVD coating techniques, evaporation techniques, sputter coating, plasma spraying, and thermal spraying. In addition, a range of organic chemistry based techniques such as sol-gel processing can be used. In such methods the surface of the grit is prepared with an organic layer, a metal carrying organic bonded to that layer, and then thermal processing, such as a rotating drum furnace under vacuum or controlled atmosphere, is used to remove the organic elements and form the carbide.

It is generally advantageous to maximise the volume of diamond or cBN and minimise the volume of metal matrix in the final composite in order to maximise the Young's modulus. This has to be balanced with retaining sufficient workability in the final material to enable the final form to be produced. A particularly useful method of increasing the total content by volume of the diamond or cBN grit is the use of bi-modal, tri-modal, or other multi-modal grit size distributions. For example, in a bi-modal grit distribution, the interstices between the particles of the larger grit size can be filled substantially with the grit particles with a smaller grit size. In a tri-modal distribution, the smallest grit size particles can fill the remaining interstices. Typically in a tri-modal (or equivalently in a bi-modal) grit distribution, the size of the different grits vary by about a factor of 10, for example comprising 4 μm, 0.4 μm, and 40 nm. Using multi-modal grit distributions it is possible to achieve more than 80% grit content by volume in a metal matrix composite. Grit size distributions may be modified further by subsequent processing of the metal matrix composite, and this can also be used beneficially. High grit densities (compared to the total fully dense solid volume) can be particularly useful in combination with porous structures.

A particularly beneficial combination, for example when using an aluminium matrix, is the use of diamond grit for the larger grit sizes, preferably coated with for example Ti, and uncoated cBN for the smaller grit sizes. This minimises the overall content of the coating metal, since the coated surface area of the grit rises rapidly as the grit size is reduced, and thus it also minimises the density of the composite whilst obtaining the benefits of a multi-modal grit distribution.

There are a wide variety of methods for forming the final metal matrix known in the art. By way of example only, a small number of variations are described here. Having selected one or more grit sizes, having performed any pre-processing such as chemical polishing or metal coating, the next stage in forming a metal matrix composite is to generally mix in the matrix metal in the form of a powder, for example using techniques such as a rotating drum mixing vessel. Formation of a processable strip may then involve the optional addition of organic binders and pouring, extruding or casting a strip comprising binder and metal matrix mixture. This strip is then compacted into the final product by a series of stages involving rolling and annealing.

Typically the initial uncompacted layer or strip is formed by casting onto a support strip made of, for example, stainless steel, although in some applications other metals including those based on Fe, Ni or Co are suitable. By drying or curing the binder the strip may be converted to the form of a self-supporting strip which has sufficient mechanical integrity to be handled and further mechanically processed after detaching it from the support strip. Alternatively some or all of the subsequent compaction and annealing stages may take place with the metal matrix strip still supported by the support strip, with separation taking place once the metal matrix strip is sufficiently mechanically robust or on processing to final form.

Formation of the final product may then comprise a series of cold or hot rolling stages with intermediate anneals, reducing the thickness of the strip, removing the binder, fully densifying the strip, and then finally reducing the strip thickness to that required by the application. By controlling the annealing stages, the degree of work hardening in the final strip can be controlled. Standard and well-known lubricants may be used to ensure that the layer passes through the rollers smoothly.

Two particular variations on the method of forming the strip will be noted:
a) The powder is dry cast onto a support metal strip such as one made from stainless steel and then the combined strip passed through at least the initial rolling stage(s) and optionally the initial annealing stage(s), with the metal matrix composite strip then being separated from the support strip and then optionally further processed by rolling/annealing. A variant on the dry powder feeds the powder directly downwards between two rollers displaced horizontally from one another, and forms a self-supporting strip without the use of a support strip;
b) A slurry is formed from the dry power by adding a mixture of water and a binder which is dispersed or dissolved in the water. Typically the binder is a cellulose binder such as methyl cellulose. The binder is carefully chosen so that it will be removed from the particulate mixture during the heat treatment step(s) after the first compaction step. Optionally there may be corrosion inhibitors added to the mixture, such as potassium dichromate or others. This slurry is then cast onto a metal support strip such as stainless steel and then dried to form a flexible film. This film may be self-supporting and separated from the support strip at this stage. Alternatively the film may be further processed on the support strip, for example being passed through at least the initial rolling stage(s) and optionally the initial annealing stage(s), with the metal matrix composite strip then being separated from the support strip and then optionally further processed by rolling/annealing.

Other variations on the method of processing may include conventional press and die technology. Single or multiple stages of hot pressing and annealing can also be used to both densify and shape the powder directly to the final dimensions and shape. Thus, shaping to final form can be an integral part of the densification process, or can be a subsequent process performed on the strip or other form of raw metal matrix composite material. In the latter case, shaping to final form can again be by methods such as cold or hot pressing. These methods of forming to final shape are considerably more straightforward than those used to manufacture components consisting of 100% of the high modulus material.

A particular feature of pressing and similar techniques is that the foil in final form generally does not have uniform thickness. In particular, areas which have been stretched to form a deviation from the initial flat layer tend to be thinner. In the case of the metal matrix speaker component this can be utilised to advantage, since the form of a speaker comprising a thinning of the foil near the apex of the three dimensionally curved region and a thickening near the skirt or tubular extension, which forms the point of attachment of the voice coil, is a particularly advantageous design, reducing the mass at a point which does not require such high strength and thus improving the acoustic properties.

Alternatively, particularly in the case of compacting directly to final form, in which the final form is preferably partially densified or porous, it is also possible to control and vary the size, form and distribution of diamond particles within the final structure and to also vary the degree of compaction or porosity. The grit size and form may be controlled at the point of addition to the mould, although this is complex to do, or it may be controlled by the degree and conditions of compaction at each point across the structure. As an example, those regions of the final structure primarily put into flexure could be made more highly porous, increasing the stiffness without increasing the mass, whilst those regions primarily under compression or tension may be more heavily compacted. These variations may be in addition or as an alternative to varying the external thickness of the structure. In the particular case of a tweeter component, the apex of the component is primarily under flexure so this may be made more porous and lower density, thus increasing the stiffness whilst allowing a reduction in mass. The thickness in this region may then increase or decrease according to the exact design and degree of porosity.

The tweeter component of this invention has a number of benefits over prior art. In particular, it offers a performance enhanced by the extreme stiffness of diamond or cBN and may even approach the stiffness of a solid diamond tweeter dome, but at lower cost, since the diamond or other ultra-hard particle content is much less costly. In addition, the methods of forming to final shape use technology which is well established, and more versatile than techniques of diamond synthesis to the final form.

In addition, the ideal tweeter component comprises a high rigidity structure with no natural resonances within or close to the bandwidth of operation. Even resonances outside but in the proximity of the bandwidth of operation (e.g. within 2 octaves, and even within 5 octaves of the bandwidth of operation) can result in distortion or harmonics within the operating or audible bandwidth. By careful tailoring of the metal matrix material it is possible to obtain the high stiffness whilst at the same time achieving damping of any resonances, thus further enhancing the sound quality produced.

In comparison to more conventional speaker technologies, the metal matrix composite comprising diamond or cBN grit provide lighter and/or more rigid solutions.

The invention will now be described, by way of example only, with reference to the following non-limiting examples:

### EXAMPLE 1

6 μm diamond grit in the as-crushed state was selected as the filler phase and cleaned chemically. The metal matrix was selected to be Al and this was prepared as 99.5% pure Al particles with an average particle size of 7-15 μm and a limit on the largest particles of <53 μm. The two components of the metal matrix material were then mixed in a mixing drum with the diamond forming 25% by volume, and then turned into a slurry by the addition of methyl cellulose in water. This was then cast onto a stainless steel support strip, dried and separated from the support strip to form a self-supporting film about typically 1.2 mm thick and 35-40% dense. This was reduced by the first rolling stage and annealing cycle to a layer about 0.45 mm thick and about 80% dense, after a second rolling and annealing cycle to 0.4 mm thick and about 99% dense, and a third rolling and annealing cycle to a fully dense layer about 0.35 mm thick. These annealing stages were typically at about 650° C. in nitrogen to drive off the binder. Further reduction of the thickness of the fully dense layer took multiple rolling passes, annealing each time the thickness compared to that at the previous anneal was about 70%, with the number of rolling passes to achieve this steadily increased from about 10 to about 40. The annealing took place in air at about 450° C. This continued until the final strip was 50 μm thick and the final anneal completed.

### EXAMPLE 2

The method of example 1 was followed except that the diamond grit was pre-coated with Ti to form a layer 20-30 nm thick by methods known in the art prior to mixing and compacting.

### EXAMPLE 3

The method of example 1 was followed except that the filler comprised 6 μm diamond grit pre-coated with Ti as in example 2, to a total % by volume of 20%, and 0.6 μm cBN grit which was not coated, to a total of 15% by volume.

### EXAMPLE 4

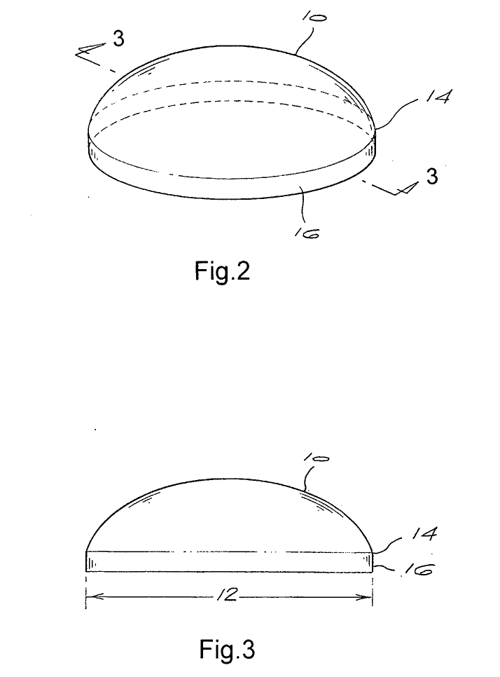

The materials produced in examples 1-3 were used to form three-dimensional stiff structures, and in particular tweeter domes for a speaker, as illustrated in FIGS. 2 and 3. The strip in final fully dense form was hot pressed into a mould using stainless steel tooling to form a tweeter 10 which had a 28 mm diameter at the widest point 12 and formed a segment of a sphere, which had a radius of 24 mm. In addition, around the edge 14 was a rim 16, forming part of a cylinder that was 28 mm in diameter, and which extended 1 mm and provided means of attachment for a voice coil former (not shown).

### EXAMPLE 5

Self-supporting strip was made by the method in example 1 to a range of thicknesses before being formed in the early stages of the processes described in examples 1-4 and removed before full densification was completed. In particular, materials with densification factors of 45%, 80% and 95% and in thicknesses from 50 μm to 200 μm were produced. These materials were then formed directly into the final shape using both hot and cold pressing techniques, and then annealed, so as to form tweeter components in final form with varying degrees of densification, similar in configuration to that illustrated in FIGS. 2 and 3. In particular, the material was hot pressed into a mould using stainless steel tooling to form a tweeter which was 28 mm diameter at the widest point and formed a segment of a sphere which had a radius of 24 mm. In addition, around the edges was a rim forming part of a cylinder 28 mm in diameter which extended 1 mm and provided means of attachment for a voice coil former.

### EXAMPLE 6

A diamond/aluminium slurry was prepared in the manner described in Example 1. This was then cast to near final shape using stainless steel tooling, dried and separated from the tooling to form a self-supporting dome structure typically 130 μm thick and about 35% dense, thinned to 110 μm near the apex of the dome. This was then compacted to final shape using two compaction/annealing stages using stainless steel tooling to obtain a dome 60 μm thick at all points and a densification of about 75% in the majority of the volume with the densification at the apex of the dome reduced to 64%. The reduced densification near the apex of the dome also enabled the grit size in this region to retain a slightly larger grit size distribution. Annealing after the first compaction was at about 650° C. in nitrogen to drive off the binder, whilst annealing after the second compaction stage was over a range of reduced temperatures in order to retain a controlled degree of work hardening in the Al.

1. A component, comprising a foil body formed of particles or grit of ultra-hard material embedded in a metal or metal alloy matrix.

2. A component according to claim 1, wherein the ultra-hard particles or grit are diamond or cBN (cubic boron nitride) particles or grit.

3. A component according to claim 1, wherein the foil body has a thickness of from 5 μm to 500 μm.

4. A component according to claim 1, wherein the foil body has a thickness of from 20 μm to 100 μm.

5. A component according to claim 1, wherein the foil body has a thickness of from 40 μm to 50 μm.

6. A component according to claim 1, wherein the foil body contains diamond or cBN particles or grit, or a mixture thereof, in a total concentration by volume exceeding 2%.

7. A component according to claim 1, wherein the foil body contains diamond or cBN particles or grit, or a mixture thereof in a total concentration by volume exceeding 10%.

8. A component according to claim 1, wherein the foil body contains diamond or cBN particles or grit, or a mixture thereof, in a total concentration by volume exceeding 30%.

9. A component according to claim 1, wherein the foil body contains diamond or cBN particles or grit or a mixture thereof, in a total concentration by volume exceeding 50%.

10. A component according to claim 1, wherein the average particle or grit size, wherein the mean diameter prior to compaction, is from 0.2 μm to 60 μm.

11. A component according to claim 1, wherein the average particle or grit size, wherein the mean diameter prior to compaction, is from 1 μm to 20 μm.

12. A component according to claim 1, wherein the average particle or grit size, wherein the mean diameter prior to compaction, is from 4 μm to 10 μm.

13. A component according to claim 1, wherein the foil body has a rigid three-dimensional shape.

14. A component according to claim 13, wherein the foil body comprises a segment of a sphere.

15. A component according to claim 13, wherein the shape of the foil body is an ellipsoid, a paraboloid or a hyperboloid with a rotational symmetry axis and no abrupt change in radius of curvature, defined by the rotation of an ellipse or other conic section.

16. A component according to claim 1, wherein the metal or metal alloy matrix is fully densified.

17. A component according to claim 1, wherein the metal or metal alloy matrix is partially densified or porous.

18. A component according to claim 1, wherein the metal or metal alloy matrix comprises a metal (pure or alloyed) selected from the group comprising aluminium, magnesium, beryllium and titanium.

19. A component according to claim 1, which is an audio component.

20. A component according to claim 19, wherein the audio component is a dome segment.

21. A component according to claim 20, wherein the dome segment has an integral coil mounting flange or tube, such that it is suitable for use as a speaker dome.

22. A component according to claim 21, wherein the speaker dome has a break-up frequency greater than 31 kHz.

23. A component according to claim 21, wherein the speaker dome has a deviation from an on-axis response curve, allowing for phase roll off and measured at 20 kHz, which is less than 5 dB.

24. A component according to claim 1, which is a high performance tweeter component.

25. A composite material comprising diamond particles or grit embedded in a metal or metal alloy matrix comprising a metal selected from aluminium, magnesium, beryllium and titanium, and combinations thereof.

26. A composite material comprising a foil body formed of diamond particles or grit embedded in a metal or metal alloy matrix, the diamond particles or grit being formed by chemical vapor deposition.

27. A composite material according to claim 26, wherein the diamond grit is non-equiaxed.

28. A composite material according to claim 26, wherein the diamond grit has as aspect ratio exceeding 1.2.

29. A composite material comprising a compacted foil body formed of particles or grit of ultra-hard material embedded in a metal or metal alloy matrix, wherein the particles or grit are selected such that the ratio of the largest particle or grit size prior to compaction to final foil thickness is in he range 0.5 to 0.05.

30. A composite material comprising a compacted foil body formed of particles or grit of ultra-hard material embedded in a metal or metal alloy matrix, wherein the particles or grit are selected such that the ratio of the largest particle or grit size after compaction to final foil thickness is in the range 0.3 to 0.05.

31. A method of manufacturing a three-dimensional structure having relatively high rigidity and low mass comprising providing a source of ultra-hard abrasive particles or grit and a metal matrix material, compacting the ultra-hard abrasive particles or grit and the metal matrix material together to for a composite strip or foil, and shaping the composite strip or foil into the three-dimensional structure.

32. A method according to claim 31, wherein the ultra-hard particles or grit are pre-coated with a metal or metal alloy prior to compaction with the metal matrix material, which metal coating may be the same as or different to the metal of the metal matrix material.

33. A method according to claim 32, wherein the metal coating is titanium or titanium based.

34. A method according to claim 31, wherein the metal matrix material is coated onto the ultra-hard particles or grit prior to compaction.

35. A method according to claim 31, wherein the ultra-hard particles or grit are diamond particles or grit.

36. A method according to claim 35, wherein the composite strip or foil comprises a bimodal, trimodal or other multimodal diamond particle or grit size distribution.

37. A method according to claim 31, wherein the source of ultra-hard particles or grit and metal matrix material are provided in dry powder form, which are combined and compacted to form a self-supporting strip.

38. A method according claim 31, wherein the rigidity or density of the three-dimensional structure is varied by varying the layer or sheet thickness, the degree of densification, the distribution of densification through the thickness, or the distribution of ultra-hard particles or grit in the plane or through the thickness of the composite strip or foil.

39. A method according to claim 38, wherein the three-dimensional structure is a speaker dome, the thickness of the strip or foil increasing towards the periphery of the speaker dome.
